(19) United States
(12) Patent Application Publication
(10) Pub. No.: US 2009/0068116 A1
(43) Pub. Date: Mar. 12, 2009

(54) Chemical system with self-timing indicator

(75) Inventor: Douglas C. Arndt, Glendora, CA (US)

Correspondence Address: WANG, HARTMANN & GIBBS, 1301 DOVE STREET, SUITE 1050, NEWPORT BEACH, CA, 92660, US

(73) Assignee: Infection Prevention System, Inc., Glendora, CA (US)

(21) Appl. No.: 12/283,541

(22) Filed: Sep. 12, 2008

Related U.S. Application Data
(60) Provisional application No. 60/960,021, filed on Sep. 12, 2007.

(51) Int. Cl. A01N 25/00; A01P 1/00; G01J 1/58; B67D 5/44; B67D 5/56

(52) U.S. Cl. 424/10.3; 252/700; 250/458.1; 222/145.5; 222/135

(57) ABSTRACT

A luminescent composition, with a luminescent marker and a ionizing agent exhibiting luminescence for an indicatory period once intermixed, and with luminance intensity remaining at a threshold intensity during indicatory period. Luminescence also can be exhibited responsive to responsive to excitatory light applied to the composition. The luminescent marker includes a coumarinic compound and the ionizing agent includes an ammonium base. Antimicrobial agents are included. A luminescence measuring apparatus includes a photoemitter and a photodetector responsive to an emissive light induced by photoemitter. An optical filter can be used with the photodetector. A two-phase composition dispensing apparatus includes a first phase reservoir, a second phase reservoir, a mixing nozzle, and a dispensing mechanism.

### CROSS-REFERENCE TO RELATED PATENTS AND PATENT APPLICATIONS

This application claims the benefit of prior-filed provisional patent application US Ser. No. 60/960,021, filed Sep. 12, 2007, which is incorporated by reference herein in its entirety. This application also is related to co-pending PCT International Application No. PCT/US2007/022954, filed Oct. 31, 2007 and entitled “HAND HYGIENE VERIFICATION/TRACKING SYSTEM AND METHOD,” and related to co-pending PCT International Application No. PCT/US2007/022843, filed Oct. 30, 2007 and entitled “VERIFIABLE HAND CLEANSING METHOD AND FORMULATION,” both of which are assigned to the same assignee hereof, and are incorporated by reference herein in their respective entirety.

### FIELD OF THE INVENTION

This invention is generally related to luminescent compositions and related methods and apparatus, in particular, to luminescent compositions used to enforce compliance with hand hygiene protocols.

### BACKGROUND

Hospital-acquired (nosocomial) infections are a major cause of illness and death, and impose serious economic costs on patients and hospitals. Indeed, health care-associated infections rank in the top five causes of death, with an estimated 90,000 deaths each year in the United States. Cross transmission is estimated to cause 40% of nosocomial infections. Pathogens are readily transmitted on the hands of a healthcare worker (HCW), and effective hand hygiene substantially reduces this transmission. For well over 150 years, handwashing has been universally accepted as one of the most important measures for preventing transmission of pathogens in health-care facilities and other community settings. However, compliance with established handwashing guidelines remains poor, averaging about 40%, internationally. The reasons for non-compliance are complex, occurring at individual, group and institutional levels.

An important factor in the efficacy of a handwashing regimen is washing time, or the amount of time a HCW actively washes their hands. In recent studies, HCWs have been observed to wash their hands for less than 24 seconds, and frequently, for less than 10 seconds, with an average of approximately 12.6 seconds. In an effort to reduce the time needed to provide sufficient hand hygiene and to increase compliance with hand hygiene guidelines, waterless hand rubs having antimicrobial agents have been developed. Even so, to be efficacious, waterless hand rubs benefit from a recommended contact time, or the amount of time during which a health care worker brings an active antimicrobial agent in contact with the skin of their hands. Frequently, due to the pressures of patient care, a HCWr may be unaware of elapsed washing or contact time, which may be insufficient. Furthermore, a hurried worker may use poor hand hygiene techniques, such as inadequate rubbing, which may increase the likelihood of cross-contaminating a patient. In some circumstances, for example, when a strict hand hygiene protocol is in effect, a health care facility may employ a covert observer to enforce compliance. However, current techniques used to monitor hand hygiene compliance typically use inferential or proxy methods, instead of direct measurement. Therefore, there is a need for apparatus, compositions, and methods of indicating acceptable hand hygiene washing or contact time.

### SUMMARY OF THE INVENTION

Embodiments of the present invention provide a luminescent composition, including a selected luminescent marker; and a selected ionizing agent, in which the selected luminescent marker exhibits luminescence for a predetermined indicatory period in response to intermixing of the first phase of the luminescent composition with the second phase of the luminescent composition, and in which a luminance intensity remains at least at a threshold intensity during predetermined indicatory period. In addition, there is provided other embodiments in which the selected luminescent marker in an intermixture of the first phase of the luminescent composition with the second phase of the luminescent composition exhibits luminescence for a predetermined indicatory period responsive to an excitatory light applied to the luminescent composition.

Also, there is provided still other embodiments including a selected antimicrobial agent combined with the first phase of the luminescent composition, in which intermixing of the first phase of the luminescent composition with the second phase of the luminescent composition comprises at least a portion of a hand hygiene protocol. Moreover, yet other embodiments are provided, in which the selected luminescent marker includes a coumarinic compound and the selected ionizing agent includes a base having an ammonium compound therein. Still other embodiments provide a luminescent composition in which the selected luminescent marker includes a coumarinic compound, the selected ionizing agent includes a base having an ammonium compound therein, and the excitatory light has a wavelength of between about 200 nm to about 400 nm. In additional embodiments, the excitatory light has a wavelength of between about 400 nm to about 700 nm. In yet additional embodiments the excitatory light has a wavelength of between about 700 nm to about 1 mm. Furthermore, in yet other embodiments the selected luminescent marker includes a coumarinic compound, the selected ionizing agent includes a base having an ammonium compound therein, the excitatory light has a wavelength of between about 200 nm to about 400 nm and the selected antimicrobial agent is ethanol, propanol, n-propanol, or an antimicrobially efficacious combination thereof, in which the selected antimicrobial agent has an alcohol concentration by weight of between about 60% and about 90%.

Embodiments of the present invention also provide an apparatus for measuring luminescence, including a photoemitter producing an excitatory light having a first wavelength range; a photodetector responsive to an emissive light induced by the excitatory light, in which the emissive light corresponds to a luminescence having a second wavelength range and at least a predetermined threshold intensity; and a processor configured to cause the a photoemitter to produce the excitatory light, configured to cause the photodetector to respond to the emissive light, and configured to cause a perceptible indication of a presence of the emissive light at an intensity of at least the predetermined threshold intensity. In other embodiments, an apparatus also includes an optical filter coupled to the photodetector and selected to pass at least a portion of the luminescence having the second wavelength range to the photodetector. In still other embodiments, an apparatus further includes a housing in which the photodetector and photoemitter are mounted; a first shielding tunnel formed in the housing and configured to receive the photoemitter; and a second shielding tunnel formed in the housing and configured to receive the photodetector and the optical filter. In such embodiments, the first shielding tunnel is positioned relative to the second shielding tunnel in a set apart, canted relationship to the other, so that at least a portion of ambient light interference is reduced thereby. In yet other apparatus embodiments, at least a portion of the first wavelength range coincides with the second wavelength range. Further embodiments include a ranging device coupled to the housing and positioned to detect a distance of a target surface relative to the housing, in which the ranging device provides a perceptible indication of the distance of the target surface relative to the housing. In certain ones of the apparatus embodiments the photodetector comprises a photovoltaic cell.

Yet other embodiments of the present invention also provide an apparatus for dispensing a two-phase composition, including a first phase reservoir configured to receive a first phase of the two-phase composition; a second phase reservoir configured to receive a second phase of the two-phase composition; a mixing nozzle in communication with each of the first phase reservoir and the second phase reservoir, in which the mixing nozzle is formed to at least partially intermix a first aliquot of the first phase with a second aliquot of the second phase, and in which the two-phase composition comprises a luminescent composition. Other embodiments of the dispensing apparatus include a dispensing mechanism that is coupled to the mixing nozzle and is configured to measuringly dispense an aliquot of the luminescent composition. Still other embodiments also provide a presence detector configured to receive a dispense request and to cause the dispensing mechanism to measuringly dispense the aliquot of the luminescent composition responsive to the dispense request. Yet other embodiments of the dispensing apparatus include an electrically-driven pump that is coupled to the presence detector and the dispensing mechanism, and is configured to measuringly dispense the aliquot of the luminescent composition responsive to the dispense request. In yet other embodiments of the invention, the mixing nozzle is formed with a mixing volute therein, and wherein the mixing volute causes the first aliquot to at least partly intermix with the second aliquot to produce the aliquot of the luminescent composition.

### BRIEF DESCRIPTION OF THE DRAWINGS

The present invention is illustrated by way of example and not by limitation in the accompanying figures, in which like references indicate similar elements, and in which:

FIG. 1 is a graphical illustration of luminance intensity, as a function of time, for a single phase luminescent composition;

FIG. 2 is a graphical illustration of luminance intensity, as a function of time, for a plural phase luminescent composition, in accordance with the teachings of the present invention;

FIG. 3 is an illustration of a photometric device, and hand hygiene compliance monitoring system, in accordance with the teachings of the present invention; and

FIG. 4 is an illustration of a two-phase luminescent composition dispenser, in accordance with the teachings of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention

### DETAILED DESCRIPTION OF THE EMBODIMENTS

The embodiments herein provide apparatus for, compositions for, and methods of, enforcing compliance with acceptable hand hygiene washing or contact time, hand hygiene technique, or both, using a chemical system incorporating a self-timed indicator, for example, a self-timed luminescent indicator. As used herein, the term “luminescence” may pertain to fluorescence, phosphorescence, and chemiluminescence, as well as to selective absorbance of predefined wavelength regions of the electromagnetic spectrum, such as infrared (IR) and near infrared (NIR).

A luminescent composition is one which emits (or absorbs) light, which is not derived from the temperature of the emitting body. In addition, the term “indicatory period” pertains to a predetermined interval of luminescence produced by a self-timed luminescent indicator. A luminescent indicator may be an evanescent luminescent indicator or a persistent luminescent indicator. An evanescent luminescent indicator may luminesce for an indicatory period on the order of about seconds to minutes, for example between about 30 seconds to about 120 seconds. A persistent luminescent indicator may luminesce for an indicatory period on the order of minutes to hours, for example, about 3 hours to about 5 hours. There may not be a sharp, objective defining point between evanescent and persistent indicatory periods, but the term may bear a functional correspondence to an application of a luminescent composition. In any event, in accordance with the teachings herein, an indicatory period corresponding to a luminescent composition may be modified to provide longer or shorter intervals of luminescence, for example, by modifying one or more constituents thereof.

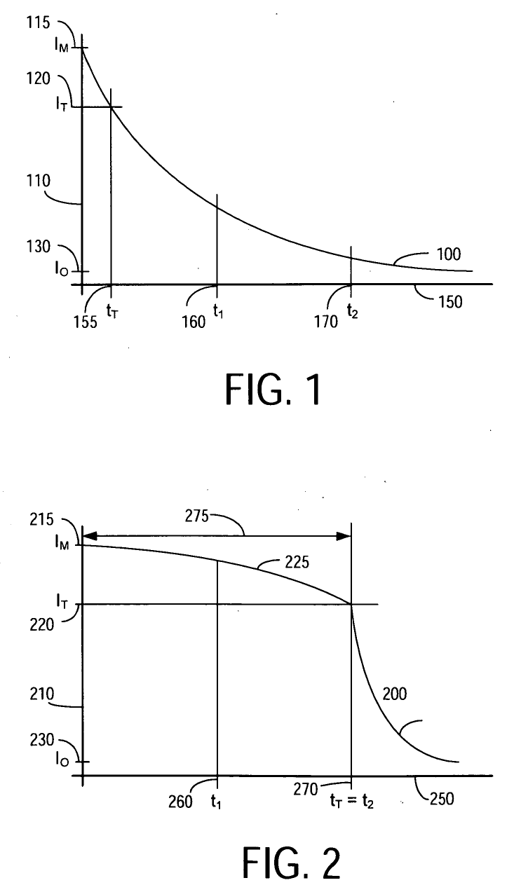

Turning to FIG. 1, luminance intensity (I) 110 characteristic of a typical mono-component luminescent material may be depicted as a function 100 of time (t) 150 elapsed after luminescent composition activation. Maximum intensity (I_{M}) 115 may be attained upon activation at t=0 seconds. However, shortly thereafter, at the interval from t=0 to t=t_{T} 155, luminescence of the material may decay rapidly towards baseline intensity (I_{O}) 130, reaching threshold intensity I_{T} 120 by t=t_{T} 155. Intermediate time marker t₁ 160 may represent a first handwashing interval from t=0, conducive to efficacious hand cleaning, for example, about 30 seconds. Later time marker t₂ 170 may represent a second handwashing interval conducive to efficacious hand cleaning, for example, about 60 seconds. For illustration purposes, the interval from t=0 to t=t_{T} is depicted to be about 5 seconds, which may be inadequate time for efficacious hand hygiene. In implementations in which photometric measurements may be used as a proxy for actual completion of efficacious hand hygiene, in particular, measurement of threshold luminance intensity I_{T} 120, the measured value may produce an incorrect inference of effective hand hygiene.

Turning to FIG. 2, a luminance intensity (I) 210 characteristic of a multi-component luminescent composition in accordance with the present embodiments also may be depicted as a function 200 of time (t) 250 elapsed after luminescent composition activation. However, present luminescent composition embodiments may be constituted to provide a predetermined indicatory period 275, during which such a present luminescent composition embodiment may display enhanced luminance intensity 225 (e.g., I_{M}≦I≦I_{T}) over predetermined indicatory period 275, may decay to approximately threshold intensity, I_{T}, 220 by the expiry of predetermined indicatory period 275. Thereafter, luminance intensity I, and may exhibit a rapid decay of intensity to approximately baseline intensity I_{O} 230. Similar to FIG. 1, intermediate time marker t₁ 260 may represent a first handwashing interval from t=0, conducive to efficacious hand cleaning, for example, about 30 seconds, and later time marker t₂ 270 may represent a second handwashing interval conducive to efficacious hand cleaning, for example, about 60 seconds. For illustration purposes, a present luminescent composition embodiment is depicted to provide a predetermined indicatory period 275 from about t=0 to about t=t₂, for example, about 60 seconds. Thus, a present luminescent composition embodiment may be conducive to efficacious hand hygiene measures. In addition, present embodiments may be disposed to measure actual hand hygiene, instead of a proxy therefor.

In selected embodiments herein, a limited amount of time may be permissible between an efficacious hand washing event and subsequent patient contact. In such embodiments, an evanescent luminescent indicator may be used, for example, about 45 seconds. Embodiments of the present invention provide a luminescent composition having an evanescent luminescent indicator, which may provide an indicatory period of between about 30 seconds to about 60 seconds. In such embodiments, luminance intensity drops off sharply after the indicatory period, indicating that an undesirable lapse of time between an efficacious hand hygiene event, and luminance intensity measurement. For example, under a hand hygiene protocol, a HCW may need to engage in a patient-related activity within about 45 seconds of an efficacious hand hygiene event. If the HCW is photometrically determined to exhibit sufficient luminescence, then the HCW may approach the patient; otherwise the HCW may need to repeat a hand hygiene procedure in accordance with the prevailing protocol. Thus, not only does the presence of evanescent luminescent indicator confirm that an efficacious hand hygiene event has been performed by the HCW, the indicator presence also confirms that the HCW performed the efficacious hand hygiene event within the indicatory period.

Luminescent compositions in accordance with present embodiments generally include a selected luminescent marker, a selected antimicrobial agent, and a selected ionizing agent. A selected ionizing agent may cause an embodiment of a luminescent composition to exhibit luminescence over a predetermined indicatory period. Typically, the form of the luminescent may be a solution or a gel, although other non-limiting examples of luminescent composition forms may include a cream, a lotion, a solution, a liquid, a soap, a shampoo, a jelly, an aerosol, a foam, or one or more constituent elements thereof.

A selected luminescent marker may include, but is not limited to, coumarinic compounds, such as 7-hydroxy coumarin (umbelliferone), 7-hydroxy-4-methylcoumarin (4-methylumbelliferone, or 4-MU), or 6-glucoside umbelliferone (esculin), and aromatic compounds having at least one fused ring (benzene derivatives). An aromatic compound with two or more fused rings (e.g. naphthalenes, anthracenes) may be used to provide a selected luminescent marker, which is strongly fluorescent when ionized in a solvent, acid, or base, for example, a selected ionizing agent. A suitable selected luminescent marker also may be a solvent-dependent or pH-dependent (environmentally sensitive) fluorophors, such as pyrene-1-sulfonyl chloride, pyrene-8-hydroxy-1,4,6-trisulfonyl chloride, quinine and its salts, quinoids including quinolines and quinines. Carbazol may be used as a selected luminescent marker, which provides a persistent luminescent indicator, in the presence of sodium hydroxide.

A suitable selected ionizing agent may be a solvent, acid, or base. In base form, a selected ionizing agent may comprise at least one alkalizing agent, which alkalizing agent may serve as a source of ammonium ions, ammonia, or both. An alkanolamide may be used as an alkalizing agent, as may any other alkalizing agent known in the art. Non-limiting examples of an alkanolamide include monoethanolamine (MEA), diethanolamine (DEA), triethanolamine (TEA), monopropanolamine (MPA), dipropanolamine (DPA), tripropanolamine (TPA), 2-amino-2-methyl-1,3-propanediol (AMPD), 2-amino-2-methyl-1-propanol (AMP), and 2 amino-2-hydroxymethyl-1,3-propanediol (THAM) and guanidium salts. Alkanolamines, alkylamines, alkali hydroxides, and alkali carbonates also may be used as other volatile bases such as, without limitation, pyridine, piperazine, amino methyl pyridines, amino ethyl pyridines, amino methoxy pyridines, amino ethyl pyrrolidines, and amino methyl piperazines.

Other non-limiting examples of ammonium sources include ammonium carbonate, ammonium carbamate, ammonium hydrogen carbonate, ammonia, and mixtures thereof, although ammonium chloride, ammonium sulphate, ammonium nitrate, ammonium phosphate, ammonium acetate, ammonium hydroxide, and mixtures thereof, also may be used as ammonium sources. In selected embodiments, a composition including a selected luminescent marker may not exhibit luminescence until at least partly mixed with a selected ionizing agent, providing a two-phase luminescent composition. Constituents described herein may be obtained, for example, from Sigma-Aldrich Corp., St. Louis, Mo., USA, or from Spectra Colors Corp., Kearny, N.J., USA

A luminescent marker and an ionizing agent may be selected to exhibit preselected luminescent characteristics.

In certain embodiments, a suitable gel may include a diluent, such as water, in which is dispersed a gellant or a thickener, for example, a hydroxyethyl cellulose (HEC) material, a hydroxypropyl cellulose (HPC) material, an ethyl hydroxyethyl cellulose (EHEC) material, a hydroxypropyl methylcellulose (HPMC), or a polyamide ester material. Cellulosic materials may be hydrophobically modified materials, for example, to enhance carrier formulation viscosity. Hydrophobic formulations also may reduce tissue staining. In one non-limiting example, a suitable carrier formulation may be a gel including water as a diluent, and between about 0.5% to about 1.0% w/w of hydroxypropyl cellulose (HPC), having a viscosity of between about 4,000 centipoise to about 6,500 centipoise (as may be referenced by the apparent viscosity of a 2% HPC aqueous solution at 25° C.), which can be obtained from Spectrum Chemicals and Laboratory Products, Inc., Gardena, Calif. 90248 USA.

Other constituents also may be chosen to modify a predetermined indicatory period. For example, a selected corresponding binder also may be added to the selected luminescent marker, in embodiments in which the marker is intended to be in the form of a bead, or a microbead, form. A selected luminescent marker and a selected corresponding binder may be formed into a particulate cluster, an aggregate, an agglomerate, or a microbead, which can be held together mechanically, electrostatically (as in a suspension), or by using a binder (dry state). In this form, the detectability of the selected marker may be relatively low until disassociated from the corresponding binder, for example, by mechanical action associated with hand washing. Vigorous rubbing of the hands after applying an efficacious amount of an embodiment of the present chemical system in bead or microbead form can cause disassociation of the selected marker from the corresponding binder, and may facilitate intermixing of the selected marker with the selected ionizer such that a luminance intensity increases to about a maximum intensity, and remains above an intensity threshold for a predetermined indicatory period. Compositions and methods for forming and using such a bead or microbead, incorporating a selected luminescent marker, may be described further in co-pending PCT International Application No. PCT/US2007/022843, filed Oct. 30, 2007 and entitled “VERIFIABLE HAND CLEANSING METHOD AND FORMULATION,” which is incorporated by reference herein in its entirety.

Alcohol-based hand rubs may be better than traditional handwashing because they tend to require less time to use, act faster, may be less irritating, and may contribute to sustained improvement in compliance associated with decreased infection rates. According to some observers, using alcohol hand rub may increase compliance to hand hygiene guideline rates by about 25%. Alcohol may have a broad antimicrobial spectrum, in that it can be active against many bacteria and clinically important viruses, yeasts, and fungi. As a result, a suitable selected antimicrobial agent for a present luminescent composition embodiment may be an alcohol. Antimicrobial efficacy can be achieved with ethanol (about 60 to about 85%), isopropanol (about 60 to about 80%), or n-propanol (about 60 to about 80%). Ethanol at high concentrations (e.g., about 95%) may be an effective treatment against naked viruses, whereas n-propanol may be effective against the resident bacterial flora. The combination of alcohols may have a synergistic effect.

In general, a present luminescent composition embodiment can be constituted to luminescence for a predetermined indicatory period on the order of about seconds to minutes, for example, between about 30 seconds to about 60 seconds, and typically about 45 seconds, after a selected antimicrobial agent has been brought into efficacious contact with a target surface, such as the skin of a user's (HCW) hands. Increased luminescence may be triggered when the selected luminescent marker is at least partly mixed with a selected ionizing agent. Alternatively, increased luminescence may be triggered when the selected luminescent marker is at least partly mixed with a selected ionizing agent, and the mixture is energized by an excitatory light source. When photometrically quantified, luminance intensity can remain substantially near or above a predetermined intensity threshold, for example, during the process of hand cleaning. Typically, after a HCW has performed efficacious hand hygiene with selected ones of present embodiments, luminance intensity may remain above a threshold intensity over a threshold interval. Following the threshold interval, a luminance intensity of an activated luminescent composition may decay sharply below a corresponding threshold intensity to approach baseline intensity.

In others of present embodiments, after a HCW has performed efficacious hand hygiene, a luminescent composition, applied to a target surface, may emit luminescence within a first wavelength range over a threshold interval. Following the threshold interval of such embodiments, the selected luminescent marker of the selected luminescent composition may emit luminescence within a second wavelength range. For example, an activated selected luminescent marker may emit a purple luminescence during a threshold interval, and may experience a frequency shift after the threshold interval and emit a blue luminescence. Each of the first wavelength range and the second wavelength range may be between about 200 nm to about 400 nm, may be between about 400 nm to about 700 nm, or may be between about 700 nm to about 1 mm. The first wavelength range and second wavelength range may at least partially overlap or may be separate. In luminescent compositions exhibiting frequency shifting characteristics, it may be possible to control whether the composition performs up-conversion after the threshold period, or performs down-conversion after the threshold period. Thus, by judicious selection of a selected luminescent marker and a selected ionizing agent, it may be possible to realize an indicatory period using luminance intensity, luminance wavelength, or both.

The following example solutions may illustrate principles described thus far, relative to present embodiments:

Example Solution #1

| Constituent | Conc. (% by weight) (approx.) |
|---|---|
| ethanol | 70% |
| water | 29.98% |
| 4-methylumbelliferone (4-MU) | 0.02% |
| ammonium carbamate | 1.0% |

Example Solution #2

| Constituent | Conc. (% by weight) (approx.) |
|---|---|
| ethanol | 69.98% |
| 4-MU | 0.02% |
| dilute (3%) ammonia solution | 30% |

Example Solution #3

| Constituent | Conc. (% by weight) (approx.) |
|---|---|
| ethanol | 70 |
| water | 28.8 |
| 4-MU | 0.2 |
| ammonium carbamate | 1.0 |

Example Solution #4

| Constituent | Conc. (% by weight) (approx.) |
|---|---|
| water | 69.8% |
| 4-MU | 0.2% |
| dilute (3%) ammonia solution | 30% |

Example Solution #5

| Constituent | Conc. (% by weight) (approx.) |
|---|---|
| glycerol | 3% |
| ethanol | 70% |
| water | 25.8% |
| 4-MU | 0.2% |
| ammonium carbamate | 1.0% |

Example Solution #6

| Constituent | Conc. (% by weight) (approx.) |
|---|---|
| ethanol | 66.8% |
| glycerol | 3% |
| 4-MU | 0.2% |
| dilute (3%) ammonia solution | 30% |

Example Solution #7

| Constituent | Conc. (% by weight) (approx.) |
|---|---|
| ethanol | 70% |
| water | 28% |
| 4-MU | 0.02% |
| ammonium carbamate | 1.0% |
| Ethylhydroxyethylcellulose (EHEC) | 0.98% |

The foregoing examples are provided for the purposes of illustration only, and in no way constitute an inclusive catalog of possible chemical systems, which may be prepared in view of the teachings herein.

Moreover, some embodiments herein also may provide persistent antimicrobial formulations, which may include persistence agents displaying residual antimicrobial activity. A persistence agent may be retained on the hands following washing as a residual skin coating, continuing to kill bacteria. A persistence agent may include, without limitation, chlorhexidine, triclosan, farnesol, lemon oil, benzalkonium chloride, or benzethonium chloride. A person of ordinary skill in the art would be knowledgeable of the characteristics and applications of persistence agents, including alternative persistence agents. In accordance with the teachings herein, luminescent compositions having persistence agents and displaying residual antimicrobial activity may, if appropriate, be modified to exhibit a persistent indicatory period, corresponding to an efficacious period of residual antimicrobial activity. Photometric quantification of luminescence on a target surface may indicate the amount of mechanical action applied to hand hygiene, the length of the hand hygiene event, the persistence of antimicrobial activity of the luminescent composition, or a combination thereof.

In addition to controlling the length of an indicatory period by judicious selection of constituent selected luminescent markers, and selected ionizing agents, luminescence can be attenuated by quenching. Quenching also may be accomplished by including a constituent of an encapsulated environment modifying additive (e.g., to raise or lower pH at a selected time after application). In addition, quenching may be effected by a reaction with oxygen (atmospheric or peroxides), by a reaction with halides (e.g., chlorides and bromides, and possibly the chlorides present on skin), by a reaction with proteins on skin (e.g., luminescence quenched when material is bound to skin proteins).

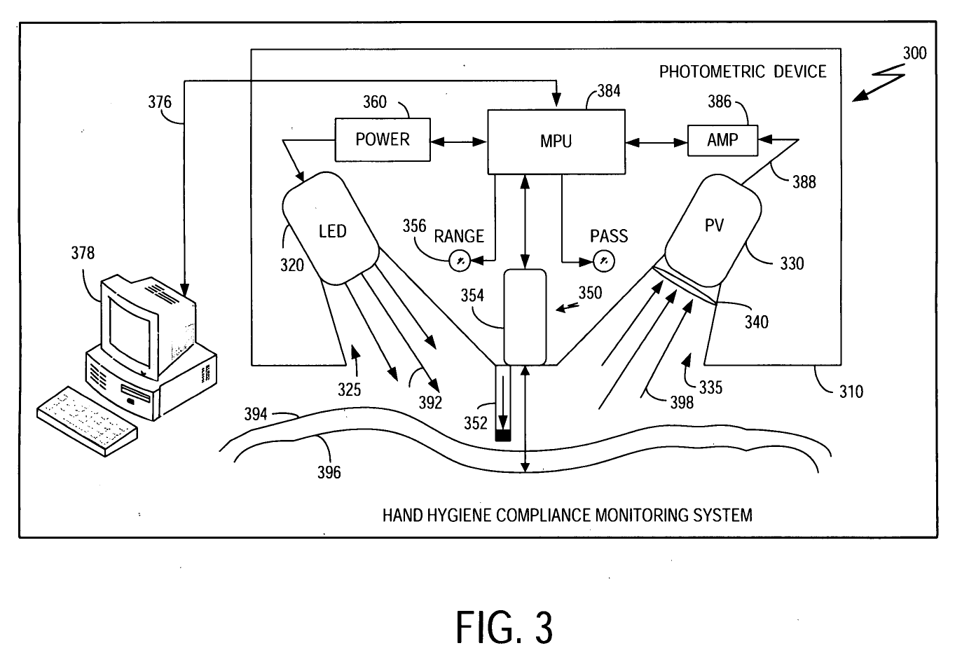

Turning to FIG. 3, example photometric device 300 is provided as a first example apparatus embodiment for enforcing acceptable hand hygiene washing or contact time, hand hygiene technique, or both. Photometric device 300 can include housing 310, photoemitter 320, and photosensor 330. Photoemitter 320 can be mounted in housing 310 in general proximity to photosensor 330, which also is mounted in housing 310. Although generally disposed in parallel within housing 310, photoemitter 320 and photosensor 330 may be angled, or canted, towards each other. In addition, one or both of photoemitter 320, and photosensor 330, may be disposed within a respective shielding tunnel, 325, 335, respectively, to reduce potential interference from ambient light.

Example photoemitter 320 may be an assembly including three (3) UV LEDs, such as a Model NSPU510CS UV LED, manufactured by Nichia America Corp., Torrance, Calif. USA. An example of photosensor 330 can be a photovoltaic device, such as CPC1822 4V Output Solar Cell, manufactured by Clare, Inc., Beverly, Mass. USA 01915. Alternatively, photosensor 330 may be a photodiode, a photoconductive detector, or a photoemissive detector, as typified by a photomultiplier tube. Typically, optical filter 340 may be used to selectively admit light within a predetermined wavelength range to photosensor 330. Typically, optical filter 340 can be a bandpass filter, but optical filter 340 also may be a high pass filter, low-pass, filter or notch filter. In addition, optical filter 340 may be disposed to receive emitted light with a first wavelength and to transmit the emitted light with a second wavelength, different from the first wavelength.

In one example embodiment of photometric device 300, optical filter 340 can be a Model #388 (yellow-green) Roscolux brand filter, manufactured by Rosco Laboratories, inc., Glendale, Calif., which serves as an optical bandpass filter with admittance in a predetermined range of UV wavelengths.

In some embodiments, photometric device 300 may include ranging device 350 to notify a user of compliance with an effective photometry range for photometric device 300. For example, for an effective photometry range for photometric device 300, a user's hands may be set apart from a predefined region of housing 310 from between about one inch to about four inches, although other effective photometry ranges may be used. Ranging device 350 may be a simple mechanical member 352 with indicia representing the effective photometry range of photometric device 300 marked thereon being perceptible to the user. Also, ranging device 350 may include sensor 354, which may be an electrical, an electromagnetic, an optical, an acousto-optical, an electro-optical, or an ultrasonic sensor, and which may sense a user within or beyond an effective photometry range of photometric device 300. Ranging device 350 also may include annunciator 356, which may provide a user with a perceptible indication of positioning relative to an effective photometry range of photometric device 300. Of course, other range detecting and indicating elements may be used. A perceptible indication may be provided, for example, by a visible light or audible tone.

In an example of an operation of compliance monitoring system 390, power supply 360 may pulse LED energizing power at an operating frequency of about 700 Hz with a forward voltage of about 3.6 volts, producing UV excitation light 392. Excitation light 392 illuminates self-timed luminescent solution 394, which may be disposed on target surface 396 (for example, an HCW hand). In response to light 392, fluorescent light 398 may be emitted from the solution. The emitted fluorescence may be filtered through optical band pass filter 340 with admittance in the UV spectrum and may then strike photosensor 330, e.g., a photovoltaic solar cell. Potential difference (Vi) 388 may be generated on the solar cell substantially corresponding to the intensity of emitted fluorescent light 398. Potential difference 388, typically an analog signal, may be received, amplified, and filtered by amplifier 386, and may be transmitted to MPU 384 for A/D conversion. MPU 384 can transmit a digitized signal representative of the intensity of emitted fluorescent light 398 to an UART disposed in PC 378, for example, over RS-232 cable 376. MPU 384 may be configured to provide 12-bit A/D conversion over a range of input voltages between about 0.0 volts to about +2.5 volts. A digital value of an A/D output may be sensed using the relationship:

ADC=4095*[(Vi−0)/(2.5−Vi)]

where
Vi is an analog voltage representative of potential difference 388, and
ADC is a digital value representative of potential difference 388.

Typically, Vi and ADC also correspond to the intensity of emitted fluorescent light 398.

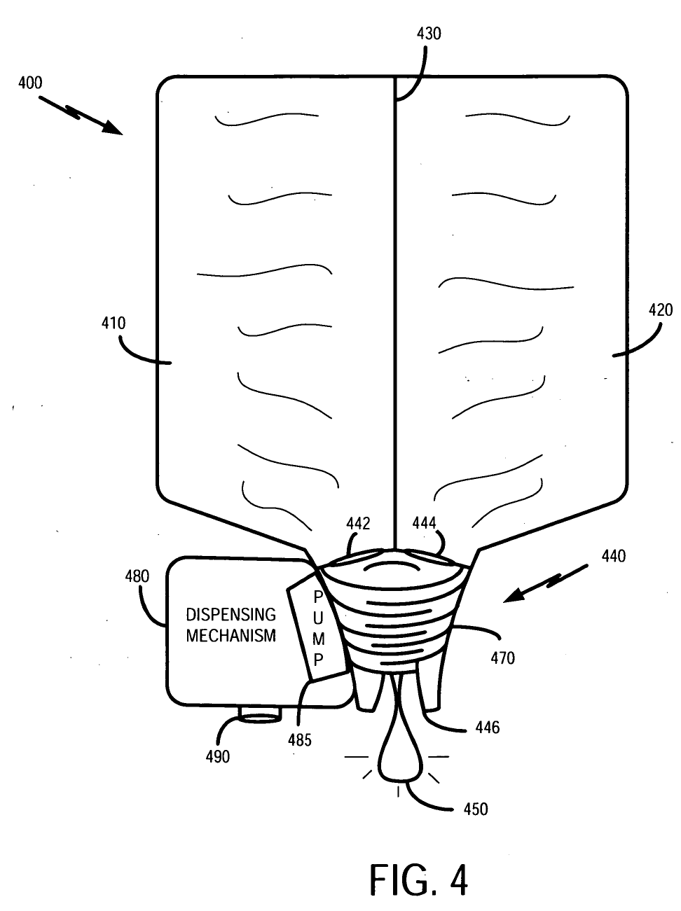

FIG. 4 illustrates an example hand hygiene composition dispenser 400 as a second example apparatus embodiment for enforcing acceptable hand hygiene washing or contact time, hand hygiene technique, or both. Dispenser 400 is depicted as a two-phase composition dispenser, although other configurations are envisioned, corresponding to the composition being dispensed. Two-phase dispenser 400 may be suitable to dispense two-phase chemiluminescent compositions. In accordance with the teachings herein, certain embodiments of a self-timed luminescent indicator, may include two or more constituents, or groups of constituents, which may intermixed at the time-of-use, for example, by a HCW.

Two-phase composition dispenser 400 may be used to dispense an efficacious amount of luminescent composition having a self-timed luminescent indicator. In selected embodiments, in which an alcohol-based waterless hand cleanser is dispensed, an efficacious amount may be between about 3 ml to about 5 ml, although other quantities may be dispensed. Dispenser 400 may include first-phase reservoir 410 separated from second-phase reservoir 420 by internal partition 430.

Dispenser 400 also may include three-port mixing nozzle 440. Mixing nozzle 440 may communicate with first-phase reservoir 410 by first port 442, and with second-phase reservoir 420 by second port 444, and may dispense composition aliquot 450, for example, to a HCW (not shown) by way of third port 446. Interposed between first port 442 and second port 444, as inlets to nozzle 440, and third port 446, as an outlet to nozzle 440, can be mixing volute 470, which may be disposed to at least partially intermix a first predetermined aliquot from first-phase reservoir 410 and a second predetermined aliquot from second-phase reservoir 420 to produce composition aliquot 450.

Dispenser 400 also may include dispensing mechanism 480, which may be disposed to measuringly dispense composition aliquot 450, responsive to a dispense request from HCW (not shown). Certain embodiments of dispensing mechanism 480 may be provided as an electro-mechanical dispenser, for example, including an electrically-driven pump 485 within mechanism 480, for example, a peristaltic pump, and presence detector 490, which may be an electro-optic detector. In such an embodiment, a dispense request may be issued, for example, by a HCW placing their hands beneath detector 490 and nozzle third port 446. In response, detector 490 may cause an electrically-driven pump 485 within mechanism 480 to measuringly dispense composition aliquot 450. Other embodiments of dispensing mechanism 480 may be provided as a mechanical dispenser, for example, a crank- or a button-operated dispensing mechanism, and a corresponding dispense request may be a HCW manually operating dispensing mechanism 480 to measuringly dispense composition aliquot 450.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as “comprising” (i.e., open language). The term “attached”, as used herein, is defined as connected, although not necessarily directly.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention, as defined by the appended claims.

What is claimed is:

1. A luminescent composition, comprising:
a selected luminescent marker comprising a first phase of the luminescent composition;
and
a selected ionizing agent comprising a second phase of the luminescent composition, wherein the selected luminescent marker exhibits luminescence for a predetermined indicatory period responsive to intermixing of the first phase of the luminescent composition with the second phase of the luminescent composition, and wherein a luminance intensity remains at least at a threshold intensity during predetermined indicatory period.

2. The luminescent composition of claim 1, wherein the selected luminescent marker in an intermixture of the first phase of the luminescent composition with the second phase of the luminescent composition exhibits luminescence for a predetermined indicatory period responsive to an excitatory light applied to the luminescent composition.

3. The luminescent composition of claim 1, further comprising:
a selected antimicrobial agent combined with the first phase of the luminescent composition, wherein intermixing of the first phase of the luminescent composition with the second phase of the luminescent composition comprises at least a portion of a hand hygiene protocol.

4. The luminescent composition of claim 2, further comprising:
a selected antimicrobial agent combined with the first phase of the luminescent composition, wherein an intermixture of the first phase of the luminescent composition with the second phase of the luminescent composition is applied to at least a portion of a human hand, and wherein application of the luminescent composition comprises at least a portion of a hand hygiene protocol.

5. The luminescent composition of claim 1, wherein the selected luminescent marker includes a coumarinic compound and the selected ionizing agent includes a base having an ammonium compound therein.

6. The luminescent composition of claim 2, wherein the selected luminescent marker includes a coumarinic compound, the selected ionizing agent includes a base having an ammonium compound therein, and the excitatory light has a wavelength of between about 200 nm to about 400 nm.

7. The luminescent composition of claim 4, wherein the selected luminescent marker includes a coumarinic compound, the selected ionizing agent includes a base having an ammonium compound therein, the excitatory light has a wavelength of between about 200 nm to about 400 nm and the selected antimicrobial agent is ethanol, propanol, n-propanol, or an antimicrobially efficacious combination thereof, and wherein the selected antimicrobial agent has an alcohol concentration by weight of between about 60% and about 90%.

8. The luminescent compound of claim 2, wherein the excitatory light has a wavelength of between about 700 nm to about 1 mm.

9. The luminescent compound of claim 2, wherein the excitatory light has a wavelength of between about 400 nm to about 700 nm.

10. An apparatus for measuring luminescence, comprising:
a photoemitter producing an excitatory light having a first wavelength range;
a photodetector responsive to an emissive light induced by the excitatory light, wherein the emissive light corresponds to a luminescence having a second wavelength range and at least a predetermined threshold intensity; and
a processor configured to cause the a photoemitter to produce the excitatory light, configured to cause the photodetector to respond to the emissive light, and configured to cause a perceptible indication of a presence of the emissive light at an intensity of at least the predetermined threshold intensity.

11. The apparatus of claim 10, further comprising:
an optical filter coupled to the photodetector and selected to pass at least a portion of the luminescence having the second wavelength range to the photodetector.

12. The apparatus of claim 11, further comprising:
a housing in which the photodetector and photoemitter are mounted;
a first shielding tunnel formed in the housing and configured to receive the photoemitter; and
a second shielding tunnel formed in the housing and configured to receive the photodetector and the optical filter,
wherein the first shielding tunnel is positioned relative to the second shielding tunnel in a set apart, canted relationship to the other, and wherein at least a portion of ambient light interference is reduced thereby.

13. The apparatus of claim 11, wherein at least a portion of the first wavelength range coincides with the second wavelength range.

14. The apparatus of claim 12, further comprising:
a ranging device coupled to the housing and positioned to detect a distance of a target surface relative to the housing, wherein the ranging device provides a perceptible indication of the distance of the target surface relative to the housing.

15. The apparatus of claim 10, wherein the photodetector comprises a photovoltaic cell.

16. An apparatus for dispensing a two-phase composition, comprising:
a first phase reservoir configured to receive a first phase of the two-phase composition;
a second phase reservoir configured to receive a second phase of the two-phase composition;
a mixing nozzle in communication with each of the first phase reservoir and the second phase reservoir, wherein the mixing nozzle is formed to at least partially intermix a first aliquot of the first phase with a second aliquot of the second phase, and wherein the two-phase composition comprises a luminescent composition.

17. The apparatus of claim 16, further comprising:
a dispensing mechanism coupled to the mixing nozzle and configured to measuringly dispense an aliquot of the luminescent composition.

18. The apparatus of claim 17, further comprising
a presence detector configured to receive a dispense request and to cause the dispensing mechanism to measuringly dispense the aliquot of the luminescent composition responsive to the dispense request.

19. The apparatus of claim 18, further comprising:
an electrically-driven pump coupled to the presence detector and the dispensing mechanism, and configured to measuringly dispense the aliquot of the luminescent composition responsive to the dispense request.

20. The apparatus of claim 16, further comprising:
a dispensing mechanism coupled to the mixing nozzle and configured to measuringly dispense an aliquot of the luminescent composition;
a presence detector coupled to the dispensing mechanism and configured to receive a dispense request; and
an electrically-driven pump coupled to the presence detector and to the dispensing mechanism, and configured to measuringly dispense the aliquot of the luminescent composition responsive to the dispense request,
wherein the mixing nozzle is formed with a mixing volute therein, and wherein the mixing volute causes the first aliquot to at least partly intermix with the second aliquot to produce the aliquot of the luminescent composition.
